(19) United States
(12) Patent Application Publication
(10) Pub. No.: US 2025/0124798 A1
(43) Pub. Date: Apr. 17, 2025

(54) SYSTEMS AND METHODS FOR PERSONALIZING EDUCATIONAL CONTENT BASED ON USER REACTIONS

(71) Applicant: edYou, Los Angeles, CA (US)

(72) Inventor: Michael Everest, Los Angeles, CA (US)

(73) Assignee: edYou, Los Angeles, CA (US)

(21) Appl. No.: 18/381,021

(22) Filed: Oct. 17, 2023

(51) Int. Cl. G09B 5/02

(52) U.S. Cl. CPC G09B 5/02

(57) ABSTRACT

Described herein are systems and methods for modifying educational content. Educational content may be provided to a user. The user's reaction to the educational content may be analyzed. This may be used to determine a content modification model, which may be used to modify the currently displayed educational content, and/or subsequent educational content. In some embodiments, a content modification model includes a taxonomy preference model. In some embodiments, a content modification model includes a toxicity reduction model.

### FIELD OF THE INVENTION

The present invention generally relates to the field of content personalization. In particular, the present invention is directed to systems and methods for personalizing educational content based on user reactions.

### BACKGROUND

A high percentage of content is uniformly presented to all users within an program. However, user needs and preferences may vary significantly. Some users may respond differently to different content depending on their backgrounds. Current methods of personalization of educational content are not satisfactory. Further, personalization of content more broadly typically requires that users actively active feedback from users. However, this may present a significant cost in terms of the user's time. However, without proper feedback from users, proper personalization of content is difficult. Together, these factors largely prevent the adoption of an effective model for personalizing content.

### SUMMARY OF THE DISCLOSURE

In an aspect, an apparatus for modification of educational content may include at least a processor; and a memory communicatively connected to the at least processor, the memory containing instructions configuring the at least processor to communicate a first set of educational content to a user device; receive a reaction datum from the user device; determine a content modification model as a function of the reaction datum; receive a content request from the user device; collect a second set of educational content as a function of the content request; determine a filtered second set of educational content as a function of the second set of educational content and the content modification model; and communicate the filtered second set of educational content to the user device.

In another aspect, a method of modifying educational content may include using at least a processor, communicating a first set of educational content to a user device; using at least a processor, receiving a reaction datum from the user device; using at least a processor, determining a content modification model as a function of the reaction datum; using at least a processor, receiving a content request from the user device; using at least a processor, collecting a second set of educational content as a function of the content request; using at least a processor, determining a filtered second set of educational content as a function of the second set of educational content and the content modification model; and using at least a processor, communicating the filtered second set of educational content to the user device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram depicting an exemplary apparatus for modifying educational content;

FIG. 2 is a diagram depicting an exemplary machine learning model;

FIG. 3 is a diagram depicting an exemplary neural network;

FIG. 4 is a diagram depicting an exemplary neural network node;

FIG. 5 is a diagram depicting an exemplary method of modifying educational content;

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for modifying educational content. In some embodiments, an apparatus may determine a user's preferences as to toxicity removal and/or educational content writing style. This may be based on, for example, training a machine learning model based on the user's reactions to educational content, such as prior instances of educational content and/or the current instance of educational content. As another example, this may be based on settings chosen by the user. In some embodiments, an apparatus may receive a request for educational content, obtain the relevant educational content, and modify it according to the user's preferences as to toxicity removal and/or educational content writing style. Apparatus may then communicate this modified content to user.

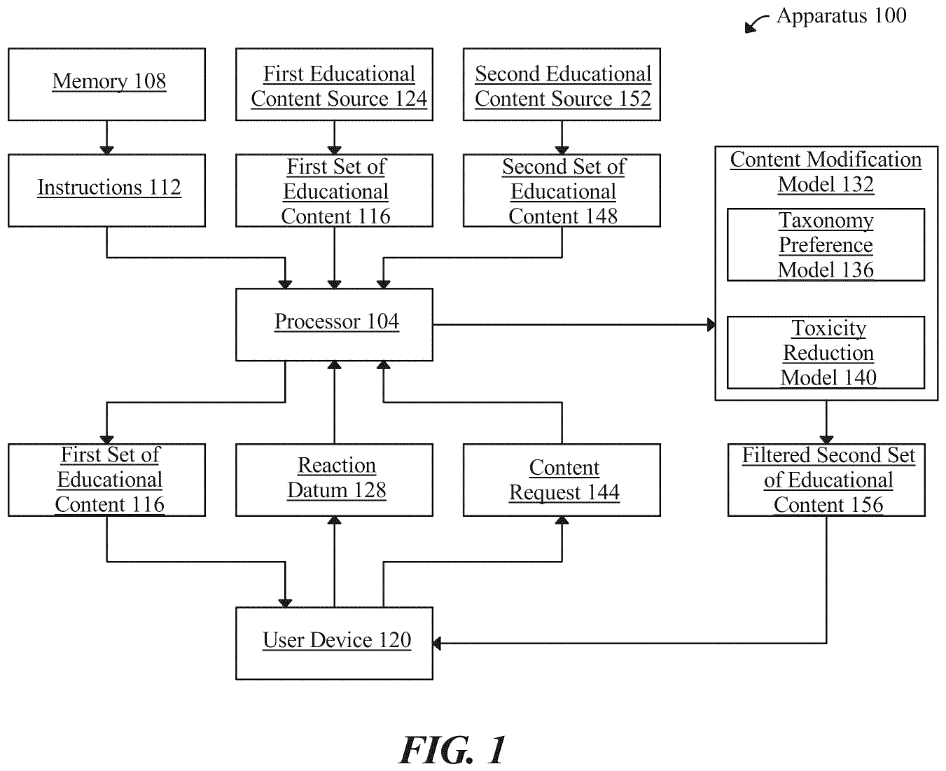

Referring now to FIG. 1, an exemplary embodiment of an apparatus 100 modifying educational content is illustrated. Apparatus 100 may include a computing device. Apparatus 100 may include a processor. Processor may include, without limitation, any processor described in this disclosure. Processor may be included in a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, apparatus 100 may include at least a processor 104 and a memory 108 communicatively connected to the at least a processor 104, the memory 108 containing instructions 112 configuring the at least a processor 104 to perform one or more processes described herein. Computing devices including memory 108 and at least a processor 104 are described in further detail herein.

Still referring to FIG. 1, as used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, in some embodiments, apparatus 100 may communicate first set of educational content 116 to user device 120. As used herein, “educational content” is digital information used for educational purposes. Educational content may take a variety of forms, such as text, video, audio, image, and the like. Non-limiting examples of educational content include a digital textbook, a recording of a lecture, a scientific journal article, and a video explaining how to write in a particular coding language. In some embodiments, first set of educational content is selected from the list consisting of a live class, live lab, live supplemental teaching session, live tutoring session, recorded class, recorded lab, recorded supplemental teaching session, recorded tutoring session, homework assignment, research subject matter, exam, or exam preparation material. Supplemental teaching sessions may include, in non-limiting examples, office hours and TA sessions. In some embodiments, first set of educational content 116 may be filtered as described below. In some embodiments, first set of educational content 116 may be communicated to user device and/or user in an unaltered form.

Still referring to FIG. 1, user device 120 may include a device operated by a user, such as a smartphone, tablet, laptop computer, desktop computer, smartwatch, vehicle media player, or digital assistant device. In some embodiments, a user may request a set of educational content from apparatus 100 using user device 120. In some embodiments, apparatus 100 may communicate a set of educational content to user device 120. In some embodiments, apparatus 100 communicating a set of educational content to user device 120 may include configuring user device 120 to communicate the set of educational content to user operating user device 120. Such communication to user may be, in non-limiting examples, in a visual format such as an image or video, or in an audio format. In some embodiments, user device 120 may include a sensor, such as an optical sensor or an audio sensor, and may record a user reaction to a set of educational content. In some embodiments, user device 120 may include an interface and user may input data indicating their reaction to educational content into the interface. In some embodiments, user device 120 may communicate data on user reaction to educational content to apparatus 100. In some embodiments, user device 120 may communicate with user operating user device 120 using a digital avatar, as described below.

Still referring to FIG. 1, in some embodiments, apparatus 100 may receive first set of educational content 116 from educational content source 124. As used herein, a “first set of educational content source” is a process, entity, user, memory, or data structure containing first set of educational content. In some embodiments, first set of educational content source 124 may include one or more databases, computing devices, and/or websites. In some embodiments, first set of educational content 116 may be received from a third party. In a non-limiting example, a third party may operate a database including first set of educational content 116, processor 104 may request first set of educational content 116 from the database using an application programming interface (API), and processor 104 may receive from the database, or a computing device associated with the database, first set of educational content 116.

Still referring to FIG. 1, in some embodiments, apparatus 100 communicating first set of educational content 116 to user device 120 may include communicating a visual element and/or visual element data structure. User device may display to user a visual element. Visual elements and visual element data structures are described below.

Still referring to FIG. 1, in some embodiments, data such as educational content may be converted into a different form. Data formats may be converted in a variety of ways, such as without limitation, using a speech to text function or using optical character recognition. In some embodiments, educational content may be converted into a different form such that it is in a form appropriate for input into a function. As a non-limiting example, a machine learning model that accepts educational content as an input may only accept inputs in a particular format, and first set of educational content 116 may be converted into that format such that it may be effectively input into such a machine learning model.

Still referring to FIG. 1, in some embodiments, apparatus 100 may receive reaction datum 128. In some embodiments, apparatus 100 may receive reaction datum 128 from user device 120. In some embodiments, reaction datum 128 may include data on a reaction to first set of educational content 116. As used herein, a “reaction datum” is a datum describing a user response to receiving educational content. User sentiment may be analyzed based on reaction datum. As used herein, “user sentiment” with respect to a user is the user's emotional reaction to educational content. Reaction datum 128 may include, in non-limiting examples, image and/or video data showing user body language and/or facial expressions while receiving educational content. As described below, body language and/or facial expressions may be analyzed using a machine vision system to determine user reaction to educational content. Another non-limiting example of reaction datum 128 includes audio data of user verbal response to educational content. As described below, user verbal responses may be converted into a different form using an automatic speech recognition system, then analyzed using a language model. Another non-limiting example of reaction datum 128 includes inputs by user operating user device 120. For example, user may click a button indicating that educational content is confusing. In another example, user may write a comment indicating that educational content uses too much jargon. User inputs in the form of language may be input into language models to analyze their meanings, as described below.

Still referring to FIG. 1, sources of reaction datum 128 may include, in non-limiting examples, data recorded by video and/or audio sensor on user device 120, data directly input into interface of user device 120, data received from a sensor not part of user device 120, data input into an interface not part of user device 120, and/or reaction datum 128 data stored in a database. In some embodiments, reaction datum 128 may be collected based on an interaction between user and a digital avatar.

Still referring to FIG. 1, reaction datum 128 may include a speech reaction datum such as a recording of user speech. For example, speech reaction datum may indicate that educational content includes a gory photograph that is undesired. In this example, apparatus 100 may use an automatic speech recognition system to analyze the speech recognition datum to convert it into another form such as a text transcript. In some embodiments, such a text transcript may be analyzed using a language model, as described below.

Still referring to FIG. 1, in some embodiments, educational content may be processed using automatic speech recognition. In some embodiments, automatic speech recognition may require training (i.e., enrollment). In some cases, training an automatic speech recognition model may require an individual speaker to read text or isolated vocabulary. In some cases, speech training data may include an audio component having an audible verbal content, the contents of which are known apriori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within educational content, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum aposteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

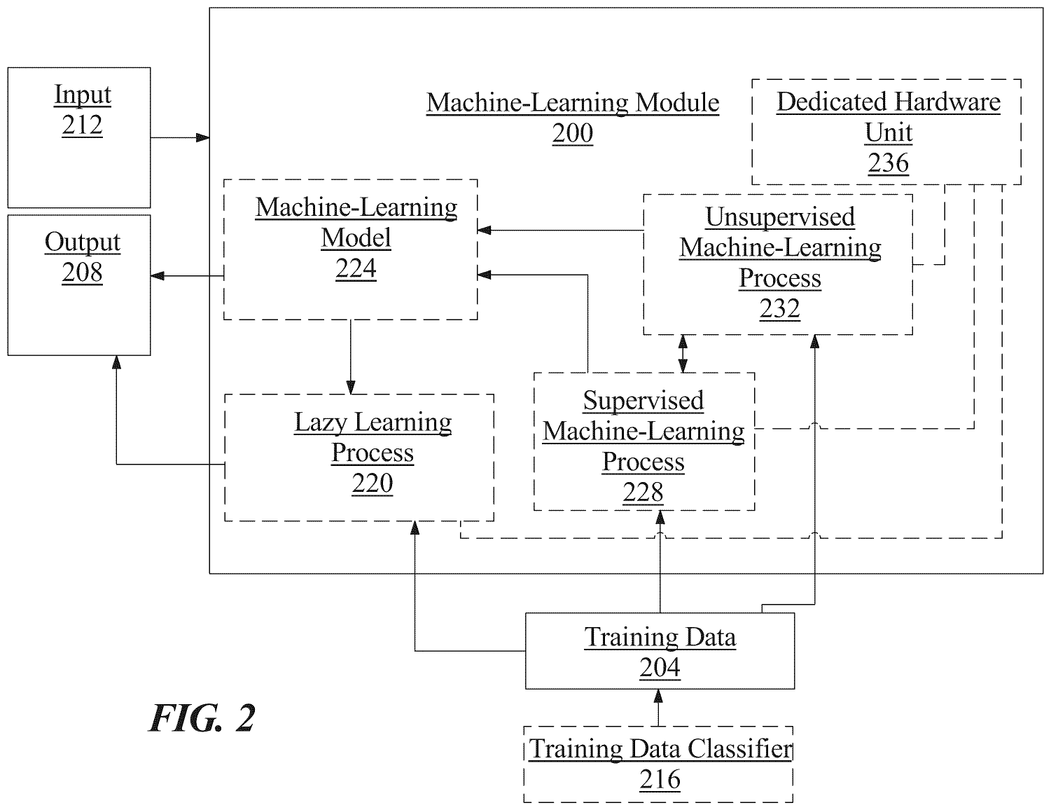

Still referring to FIG. 1, in some embodiments, an automatic speech recognition process may include a neural network. Neural network may include any neural network, for example those disclosed with reference to FIGS. 2-4. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 1, in some embodiments, reaction datum 128 may include physical movements such as body language or facial expressions which may be detected using a machine vision system. In some embodiments, apparatus 100 may include at least a camera. In some embodiments, user device 120 may include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it refers to generation and/or formation of an image.

Still referring to FIG. 1, in some embodiments, apparatus 100 may include a machine vision system. In some embodiments, a machine vision system may include at least a camera. A machine vision system may use images, such as images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 1, an exemplary machine vision camera is an OpenMV Cam H7 from OpenMV, LLC of Atlanta, Georgia, U.S.A. OpenMV Cam comprises a small, low power, microcontroller which allows execution of machine vision applications. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 1, in some embodiments, a machine vision system may be used to determine a user's reaction to educational content. For example, a machine vision system may be used to determine a feature of the user's reaction to the educational content, such as the degree to which a user's reaction to educational content is positive, negative, and/or reflects specific emotions or states of mind such as confusion, frustration, understanding, and the like. In some embodiments, determining a user's reaction to educational content may involve use of one or more machine learning models. For example, a machine learning model may be trained to accept as inputs image and/or video data depicting a user receiving educational content. Such a machine learning model may be trained to output whether, and/or to what extent, certain reaction features are present.

Still referring to FIG. 1, in some embodiments, a supervised learning algorithm may be used to train such a model. For example, such a machine learning model may be trained on a dataset including many video files of prior users observing educational content, with each file associated with one or more data points indicating how the user reacted to the educational content. Such training data may be obtained by, for example, recording videos of users receiving educational content, and taking surveys of those users; an exemplary training data set may include video files of those users and be associated with data on how users reacted to the educational content, which may be determined as a function of the survey data. In some embodiments, a training data set may be obtained by recording images and/or videos of users receiving educational content and manually assigning each element of the data set one or more features. For example, a panel of humans may view each reaction and score it across categories such as the degree to which the response is positive, the degree to which the response shows confusion, and the degree to which the response shows frustration; this may be done based on the humans' perception of the facial expressions and/or body language of the user. In some embodiments, a training data set may include image and/or video data, associated with a degree of positivity (or negativity) of a depicted user reaction. In some embodiments, a training data set may include image and/or video data, associated with whether features such as confusion, frustration, understanding, interest, and boredom are present.

Still referring to FIG. 1, a variety of algorithms, such as classification or regression algorithms, may be used in such a machine learning model. Which algorithm is selected may depend on variables such as features of the dataset, the amount of computing power available, and the type of output desired. A convolutional neural network may be used. A convolutional neural network may be able to detect features in certain regions of an image and create a feature map in a hidden layer of the convolutional neural network. For example, convolutional neural network may detect edges in a feature map. Additional layers of the network may convert this feature map into an output indicating whether, or the degree to which, certain reactions are present. In some embodiments, a machine vision model that is tolerant to translation of a set of features from one part of an image to another may be selected. Selecting such a model may allow a machine vision system to, for example, recognize a certain facial expression regardless of where the face is in the frame. In some embodiments, a convolutional neural network tolerant to such translation may be used.

Still referring to FIG. 1, in some embodiments, a machine vision system may be applied to video data. In some embodiments, a machine vision system may be applied to an entire video file. In some embodiments, a machine vision system may be applied to a subset of the frames of a video file. Which frames are chosen may be selected in order to, for example, determine a user's reaction to a certain element of educational content received by the user at that time. How frequently frames are chosen may depend on, for example, the type of machine learning algorithm chosen, the amount of computing power available, and a tolerance for inaccuracy based on not analyzing all available data.

Still referring to FIG. 1, in some embodiments, a machine vision system may be used to analyze educational content to determine whether certain features are present. For example, machine vision may be used to determine whether a photograph depicts gory content. In such a system, many of the same techniques described above may be used. For example, a machine learning model may be trained to accept as inputs image and/or video data included in educational content. Such a machine learning model may be trained to output whether, and/or to what extent, certain features such as gore are present. Such a machine learning model may be trained on a dataset including many video files of educational content, with each file associated with one or more data points indicating whether gore is present. Such training data may be obtained by, for example, obtaining images and manually assigning each element of the data set one or more features, such as whether gore is present.

Still referring to FIG. 1, in some embodiments, a machine learning model may be trained entirely using a method described herein. In some embodiments, a model already trained to detect certain features may be used or modified to fit specific needs. For example, a model may be trained to detect emotions and/or reaction features from facial expressions and/or body language generally and may be adapted to detect emotions for a specific purpose described herein. For example, certain emotions and/or reaction features may be of greater interest than others. As non-limiting examples, disgust may indicate that a feature of educational content may need to be removed, confusion may indicate that a more simplified form of educational content is best, engagement may indicate that the educational content is appropriate, and boredom may indicate that a more in depth form of the educational content is best.

Still referring to FIG. 1, in some embodiments, a language model may be used to interpret language from a user. For example, automatic speech recognition may be used to detect user speech and convert it into a machine readable format such as a text format, and a language model may be used to interpret that text. In some embodiments, a language model may be used to process reaction datum 128. As used herein, a “language model” is a program capable of interpreting natural language, generating natural language, or both. In some embodiments, a language model may be configured to interpret the output of an automatic speech recognition function and/or an OCR function. A language model may include a neural network. A language model may be trained using a dataset that includes natural language.

Still referring to FIG. 1, generating language model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, processor 104 may determine one or more language elements in reaction datum 128 by identifying and/or detecting associations between one or more language elements (including phonemes or phonological elements, morphemes or morphological elements, syntax or syntactic elements, semantics or semantic elements, and pragmatic elements) extracted from at least user data and/or response, including without limitation mathematical associations, between such words. Associations between language elements and relationships of such categories to other such term may include, without limitation, mathematical associations, including without limitation statistical correlations between any language element and any other language element and/or Language elements. Processor 104 may compare an input such as a sentence from reaction datum 128 with a list of keywords or a dictionary to identify language elements. For example, processor 104 may identify whitespace and punctuation in a sentence and extract elements comprising a string of letters, numbers or characters occurring adjacent to the whitespace and punctuation. Processor 104 may then compare each of these with a list of keywords or a dictionary. Based on the determined keywords or meanings associated with each of the strings, processor 104 may determine an association between one or more of the extracted strings and a feature of first set of educational content 116, such as an association between a string containing the consecutive words “bad” and “words” and educational content that includes profanity. Based on the determined keywords or meanings associated with each of the strings, processor 104 may determine an association between one or more of the extracted strings and a feature that user prefers or does not prefer, such as an association between a string containing the words “too” and “complicated” and educational content that includes too much jargon for that user. Associations may take the form of statistical correlations and/or mathematical associations, which may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory.

Still referring to FIG. 1, processor 104 may be configured to determine one or more language elements in reaction datum 128 using machine learning. For example, processor 104 may generate the language processing model by any suitable method, including without limitation a natural language processing classification algorithm; language processing model may include a natural language process classification model that enumerates and/or derives statistical relationships between input terms and output terms. An algorithm to generate language processing model may include a stochastic gradient descent algorithm, which may include a method that iteratively optimizes an objective function, such as an objective function representing a statistical estimation of relationships between terms, including relationships between input language elements and output patterns or conversational styles in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrase, and/or other semantic unit. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Still referring to FIG. 1, processor 104 may be configured to determine one or more language elements in reaction datum 128 using machine learning by first creating or receiving language classification training data. Training data may include data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below.

Still referring to FIG. 1, language classification training data may be a training data set containing associations between language element inputs and associated language element outputs. Language element inputs and outputs may be categorized by communication form such as written language elements, spoken language elements, typed language elements, or language elements communicated in any suitable manner. Language elements may be categorized by component type, such as phonemes or phonological elements, morphemes or morphological elements, syntax or syntactic elements, semantics or semantic elements, and pragmatic elements. Associations may be made between similar communication types of language elements (e.g. associating one written language element with another written language element) or different language elements (e.g. associating a spoken language element with a written representation of the same language element). Associations may be identified between similar communication types of two different language elements, for example written input consisting of the syntactic element “that” may be associated with written phonemes /th/, /ă/, and /t/. Associations may be identified between different communication forms of different language elements. For example, the spoken form of the syntactic element “that” and the associated written phonemes above. Language classification training data may be created using a classifier such as a language classifier. An exemplary classifier may be created, instantiated, and/or run using processor 104, or another computing device. Language classification training data may create associations between any type of language element in any format and other type of language element in any format. Additionally, or alternatively, language classification training data may associate language element input data to a feature of educational content that an associated user would prefer or would not prefer. For example, language classification training data may associate occurrences of the syntactic elements “too,” “much,” and “swearing,” in a single sentence with the preference of educational content containing less profanity.

Still referring to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)=P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

Still referring to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 1, in some embodiments, apparatus 100 may determine content modification model 132 as a function of reaction datum 128. As used herein, a “content modification model” is a set of rules for modifying educational content that includes a taxonomy preference model, a toxicity reduction model, or both. In some embodiments, content modification model 132 may include taxonomy preference model 136. In some embodiments, content modification model 132 may include toxicity reduction model 140.

Still referring to FIG. 1, apparatus may generate content modification model 132. Processor 104 may be configured to utilize a trained content modification model 132 to modify language based on a set of language to be modified such as a set of educational content and a language model setting. For example, a trained content modification model 132 may receive a set of language to be modified and a language model setting as an input. Alternatively, multiple content modification models 132 may be options, and which is used may depend on a setting. A trained content modification model 132 may generate output corresponding to the content of the language to be modified and a setting. For example, content modification model 132 may reproduce the content of a page of a digital textbook, but with technical language replaced by language more understandable to a layperson. Content modification model 132 may create an output in a particular communication style, such as a style identified by language model settings. A “style,” as used herein with reference to communication, is a pattern of language elements. For example, content modification model 132 may be trained with language classification training data associating particular words, phrases, or language elements with a particular style of communication such as a formal writing style, a concise writing style, a verbose speaking style, a writing style associated with a particular country, a writing style associated with academics, a writing style easily understandable by laypeople, and the like. For example, settings may indicate that a user desires concise information and a user may request a particular piece of educational content; in this case, content modification model 132 may output a version of the educational content that is more concise than the original.

Still referring to FIG. 1, in some embodiments, processor 104 may present information using a default communication style. In some embodiments, a default communication style may include unmodified educational content. Processor 104 may receive direct or indirect feedback from user 120 indicating that user would prefer a different communication style. As non-limiting examples, user may manually change settings in order to receive output in a particular communication style, user may make a facial expression and use body language indicating that they are confused, or user may verbally express an opinion on the writing style. For example, user may verbally express “this is too long” and processor 104 may use content modification model 132 to output a replacement set of educational content that is written in a more concise style. In some embodiments, processor 104 may determine a user's preferred communication style over time, based on data from the user's interaction with multiple items of educational content.

Still referring to FIG. 1, processor 104 may adapt educational content by receiving training data correlating exemplary language elements with exemplary communication styles, training a machine learning model using the received training data, and generating one or more natural language outputs corresponding to the determined entity communication style by inputting, to the trained content modification model 132, a set of educational content and receiving a filtered set of educational content output from the trained content modification model 132.

Still referring to FIG. 1, in some embodiments, content modification model 132 may include taxonomy preference model 136. As used herein, a “taxonomy preference model” is a set of rules for modifying educational content such that the meaning of the educational content is kept the same or similar, but the specific words, phrases, sentences or the like used to communicate the educational content is changed according to user preferences. In some embodiments, user preferences may be determined based on reaction datum 128. Machine vision techniques for determining user preferences are described above. In non-limiting examples, taxonomy preference model 136 may be trained to put educational content in layman's terms, use more technical or precise language, change language between American English and British English, add or remove slang, and/or use or remove specific language that user prefers or does not prefer. Taxonomy preference model 136 may include a taxonomy preference machine learning model. Taxonomy preference machine learning model may be trained to alter language such that the meaning of the language is kept the same or similar, but the specific words, phrases, sentences, or the like used are changed according to user preferences.

Still referring to FIG. 1, in some embodiments, supervised learning may be used to create a taxonomy preference machine learning model that accepts educational content as an input and outputs modified educational content. For example, taxonomy preference machine learning model may be trained to change educational content from American English to British English and may be trained on a training dataset including samples of American English language, associated with British English language with the same or similar meaning. Such a taxonomy preference machine learning model may accept as an input language and may output a version of that language modified to be in British English. In some embodiments, a machine learning model may be trained based on content with which a user had a positive reaction. For example, once a sufficient amount of data is collected, a machine learning model may be trained on a dataset including educational content and modified educational content to which user had a positive reaction. In some embodiments, multiple such machine learning models may be used depending on settings, which may be based on user reaction data.

Still referring to FIG. 1, in some embodiments, a plurality of taxonomy preference machine learning models may be used, where each is capable of modifying educational content in a specific way, and where one or more such models may be used; which such models are used may be determined based on setting. For example, taxonomy preference machine learning model may be trained on a dataset including samples of language, associated with how they are modified and resulting modifications. Such a taxonomy preference machine learning model may accept as an input language and how it is to be modified and may output a version of that language modified in that way. Non-limiting examples of modifications that taxonomy preference machine learning model may be trained on include adding or removing technical language, changing language used to a style of a specific region or a specific population, and changing language to be more or less concise. Training data may be obtained from, in non-limiting examples, manual translations of language from a first style to a second style, databases containing language in different styles, and descriptions of similar subject matter from individuals known to use specific styles. For example, taxonomy preference model may include a plurality of taxonomy preference machine learning models, wherein each of the plurality of taxonomy preference machine learning models is trained to modify educational content language, wherein determining a filtered second set of educational content as a function of the second set of educational content and the content modification model includes selecting a taxonomy preference machine learning model from the plurality of taxonomy preference machine learning models, inputting the second set of educational content into the taxonomy preference machine learning model, and receiving from the taxonomy preference machine learning model the filtered second set of educational content.

Still referring to FIG. 1, in some embodiments, taxonomy preference machine learning model may be trained using reinforcement learning. In some embodiments, apparatus 100 may train taxonomy preference machine learning model based on reactions by a specific user or group of users. For example, machine vision, automatic speech recognition, language model, and/or direct user inputs may be used to determine whether user has a positive response to educational content, and the degree of positivity (or negativity) of the user response may be used as a cost function to train the taxonomy preference machine learning model. In some embodiments, a reaction other than positivity or negativity may be accounted for in a cost function. For example, confusion and/or frustration may have costs such that reinforcement learning model is trained to minimize confusion and/or frustration. In some embodiments, degree of positivity, degree of negativity, or another feature may be used to train taxonomy preference machine learning model. In some embodiments, degree of positivity, degree of negativity, or another feature may be used to determine user settings. For example, processor may assess the degree of technicality of an item of educational content, and the degree of positivity of the user response, and may adjust settings for the user.

Still referring to FIG. 1, in some embodiments, processor 104 may modify educational content based on rules, which may be applied to a subset of educational content. For example, a user skilled in biology but not in particle physics may configure settings such that only particle physics related educational content is put in layman's terms or may be found to respond well to biology content in technical terms and particle physics content in layman's terms. Rules may be applied to subsets of educational content based on, in non-limiting examples, subject matter, format, document source, or other ways to categorize educational content. For example, a subject matter categorization may apply a first set of rules to an astronomy related item of educational content and a second set of rules to a chemistry set of educational content. As another example, a categorization based on educational content type may apply a first set of rules to a lecture and a second set of rules to a scientific paper. As another example, a categorization may apply a first set of rules to educational content from a first author or institution and a second set of rules to educational content from other authors or institutions.

Still referring to FIG. 1, in some embodiments, content modification model 132 may include toxicity reduction model 140. As used herein, a “toxicity reduction model” is a set of rules for modifying educational content such that the educational value of the educational content is kept the same or similar, but profanity, gory content, otherwise explicit content, content that has undesirable themes, or a combination of these content types is mitigated. For example, a lecture may include profanity, and toxicity reduction model 140 may alter the lecture such that the profanity is removed, replaced with a different word, or the like. In another example, research materials included in educational content for a criminal law student may include a gory photograph, and toxicity reduction model 140 may change the gory photograph to be in black and white, blur it, obscure it entirely, obscure specific parts of it, or the like. In another example, a business school case may include references to gambling, and toxicity reduction model 140 may change those references to be unspecific. Additional examples of uses of toxicity reduction model 140 may include removing negative language, removing aggressive language, and removing misinformation. In some embodiments, toxicity reduction model may modify educational content based on user preferences. Machine vision techniques for determining user preferences are described above.

Still referring to FIG. 1, in some embodiments, toxicity reduction model 140 may include a toxicity reduction machine learning model. Toxicity reduction machine learning model may be trained on a dataset including educational content, and versions of the educational content with undesirable elements removed. Such toxicity reduction machine learning model may accept as an input educational content and may output educational content with undesirable elements removed. As described with respect to taxonomy preference model 136, toxicity reduction model 140 may include multiple toxicity reduction machine learning models and may select which one(s) to apply based on settings, which may be based on reaction datum 128. For example, a first toxicity reduction machine learning model may be trained to blur gory photographs. Such a toxicity reduction machine learning model may be trained on a dataset including educational content, associated with educational content where gory photographs have been blurred. In another example, a second toxicity reduction machine learning model may be trained to remove profanity. Such a toxicity reduction machine learning model may be trained on a dataset including educational content, associated with educational content where profanity has been removed or replaced with substitute words. Also as described with respect to taxonomy preference model 136, toxicity reduction model 140 may include a toxicity reduction machine learning model that accepts both a setting and educational content as inputs, and modifies educational content based on the setting. For example, reaction datum 128 may indicate that a particular user has a negative reaction to gory photographs but does not have a negative reaction to profanity; in this example, processor may utilize settings such that toxicity reduction model 140 mitigates gory photographs, but not profanity for that user. Also as described with respect to taxonomy preference model 136, toxicity reduction model 140 may utilize reinforcement learning to directly train toxicity reduction machine learning model and/or select which setting to apply.

Still referring to FIG. 1, in some embodiments, toxicity reduction model 140 may mitigate undesirable elements of photo and/or video educational content. In some embodiments, machine vision may be used to detect undesirable elements in images and/or videos based on settings. Machine vision techniques for analyzing image and/or video content is described above. As described above, multiple toxicity reduction machine learning models may be used. Which toxicity reduction machine learning model is selected to modify an item of educational content may be based on user preferences. For example, if user preferences indicate that a user is tolerant to gore but not depictions of people smoking, then a toxicity reduction machine learning model trained to blur images of people smoking may be applied. If an undesirable element is detected, it may be mitigated, such as by blurring or completely obscuring that region, blurring, or completely obscuring the entire image or video, changing aspects of the image or video such as lowering contrast, or changing it to black and white, and the like. In a non-limiting example, if a gory photograph is detected and previous reaction data 128 associated with user indicated that user responds poorly to gory photographs, then the gory portion of the photograph may be blurred. For example, toxicity reduction model may include a plurality of toxicity reduction machine learning models, wherein each of the plurality of toxicity reduction machine learning models is trained to modify educational content language, wherein determining a filtered second set of educational content as a function of the second set of educational content and the content modification model includes selecting a toxicity reduction machine learning model from the plurality of toxicity reduction machine learning models, inputting the second set of educational content into the toxicity reduction machine learning model, and receiving from the toxicity reduction machine learning model the filtered second set of educational content.

Still referring to FIG. 1, mitigation strategies that may be applied when undesirable content is detected may include, in non-limiting examples, removing the undesirable content, obscuring the undesirable content, and changing the undesirable content. In some embodiments, a warning may be communicated to the user in addition to and/or instead of mitigating the undesirable content. In some embodiments, user may be given the option to receive undesirable content, such as by clicking a button to remove an obscuring effect, or by dismissing a warning.

Still referring to FIG. 1, and as described above with respect to taxonomy preference model 136, in some embodiments, processor 104 may achieve the purposes of toxicity reduction model 140 by employing rules to certain subsets of content; this may be done based on user preferences. For example, some users may wish to see content largely unaltered, but with warnings, obscuring effects, and the like only applied in extreme scenarios. However, other users, such as children, may have settings such that undesirable content is more aggressively mitigated.

Still referring to FIG. 1, in some embodiments, the performance of a machine learning model such as taxonomy preference machine learning model or toxicity reduction machine learning model may be assessed by the positivity of reaction datum 128, where reaction datum 128 is collected from a reaction to a set of educational content that was filtered based on the machine learning model. In some embodiments, a statistically significant sample of reaction data 128 may be collected and assessed to determine performance of a taxonomy preference machine learning model and/or toxicity reduction machine learning model. In some embodiments, the performance of a machine learning model may be assessed using the factors described herein for determining a degree of certainty with respect to a user preference variable. For example, if a degree of certainty is or would be high, then a machine learning model may be performing well, but if a degree of certainty is or would be low, then a machine learning model may not be performing well.

Still referring to FIG. 1, in some embodiments, an item of educational content may contain multiple features that a user may potentially react to, and user expressions may not be 100% explained by the features of educational content that the user is viewing. For example, if a user's expression indicates frustration in response to an item of educational content that is long, contains profanity, and contains complex technical language, it may not be entirely clear which of these features, if any, caused the user's frustration. In some embodiments, content modification model 132 may account for the presence of multiple educational content features and outside influences on user emotion using user preference variables as described below.

Still referring to FIG. 1, in some embodiments, processor 104 may determine features of educational content. Methods of determining educational content features are described elsewhere herein. As non-limiting examples, machine vision techniques may be used to determine whether an image is gory, a language model may be used to determine whether text contains complex terminology, or a combination of an automatic speech recognition system and a language model may be used to determine whether an audio file contains profanity. Processor 104 may track many user preference variables with respect to a user, with each user preference variable representing the user's tolerance to and/or preference for a certain feature of educational content. As non-limiting examples, processor 104 may track as separate variables a user's tolerance for profanity, gory content, and complex terminology. Each user preference variable may be adjusted based on the relevant user's reactions to educational content including that feature. For example, if a user has a negative response to educational content that contains profanity and gory content, then those user preference variables may be adjusted such that the content modification model 132 is more likely to mitigate those features in future educational content. In some embodiments, such adjustments may be relatively small, such that individual reactions do not greatly adjust the modifications made to educational content. In some embodiments, this may lessen the likelihood that user preference variables other than ones that the user has a reaction to are too heavily modified. For example, if a user is displayed many items of educational content, and has a negative reaction to all, or a very high percent, of the ones in which gory content is displayed, but only a small percent of the ones in which profanity is present (perhaps because there is overlap between those categories), then over the whole dataset, a user preference variable associated with the user's tolerance to gory content may be modified much more heavily than a user preference variable associated with the user's tolerance to profanity. Such variables may have widely ranging levels of granularity. For example, a user preference variable may indicate a user's tolerance to profanity generally. In another example, a user preference variable may indicate a user's tolerance to a particular swear word.

Still referring to FIG. 1, in some embodiments, a user preference variable may be adjusted based on how prominent a relevant feature is in educational content. For example, if a user expresses a negative response to an item of educational content that includes excessive profanity but only a minor amount of complex terminology, then that may cause a larger adjustment in a user preference variable associated with the user's tolerance for profanity than in a user preference variable associated with the user's tolerance for complex terminology.

Still referring to FIG. 1, in some embodiments, certain reaction types may be more relevant to certain features of educational content across an entire population. In those situations, user preference variables associated with user tolerance to certain features of educational content may be adjusted according to the relevance of the reaction type to the feature. For example, statistics across an entire population may indicate that, where educational content is long and contains gory content, and a user expresses disgust, the gory content may be the problem, whereas if the user instead expressed boredom, then the length of the content may be the problem. Content modification model 132 may adjust a user preference variable associated with a user's tolerance for gory content more heavily in the first of these situations and may adjust a user preference variable associated with a user's tolerance for long content more heavily in the second of these situations.

Still referring to FIG. 1, in some embodiments, certain reaction types may be more relevant to certain features of educational content across sub-populations. For example, content modification model 132 may be configured to make larger adjustments to user preference variables associated with tolerance to profanity for young users than older users. In some embodiments, apparatus 100 may collect user data in order to determine which sub-population a user fits into. Exemplary user data which may be collected includes demographic and educational information about a user. User data may be received, in non-limiting examples, directly from a user such as by input into a digital form, or from another source such as an educational institution. User data may be used to determine initial settings for a user. For example, a user in medical school may be more tolerant to technical biology terms than a user taking an advanced placement biology class in high school, who may be more tolerant to those terms than a 4^{th} grader.

Still referring to FIG. 1, in some embodiments, a user and/or a user preference variable may be associated with a variable indicating a degree of certainty. For example, a user who has never used apparatus 100 before may be assigned a low degree of certainty with respect to a user preference variable associated with the user's tolerance for profanity. Once the user has used apparatus 100 a substantial amount and many data points have been collected with respect to the user's tolerance for profanity, the degree of certainty variable may shift to indicate a higher degree of certainty. Such a degree of certainty variable may be used to, for example, speed up an initial calibration or account for a change in preference. For example, if a user preference variable remains relatively stable across many data points relevant to that user preference variable, then an associated degree of certainty may be high. In another example, if a user preference variable that was once stable starts consistently shifting in a particular direction with each new relevant data point, this may indicate a shift in user preferences and an associated degree of certainty may decrease. In some embodiments, the magnitude of modifications to user preference variables may be higher where degree of certainty is low.

Still referring to FIG. 1, in some embodiments, the magnitude of a change in a user preference variable may be adjusted based on whether the user is paying attention to the educational content. For example, if machine vision indicates that the user is looking away from the screen, then a user reaction may be unrelated to educational content features, and adjustments based on those reactions may be minor or zero. In another example, if a user has a window associated with apparatus 100 minimized, and a reaction is detected, then user preference variables associated with features of visual educational content may not be modified, while user preference variables associated with features of audio educational content may still be modified.

Still referring to FIG. 1, in some embodiments, apparatus 100 may receive content request 144. As used herein, a “content request” is a signal indicating that a user is to see educational content. In some embodiments, content request 144 may originate from user device 120. In some embodiments, content request 144 may originate from a different device such as a device operated by a professor teaching a class in which user is a student. In some embodiments, content request 144 may specify the educational content to be shown. In some embodiments, content request 144 may not specify educational content and it may be determined by processor 104 or looked up using another source such as a database. In some embodiments, apparatus 100 may receive content request 144 from user device 120. User may, for example, ask a digital avatar displayed by user device 120 to provide a particular scientific paper, and user device 120 may transmit content request 144 to processor 104 as a result. In another example, user may tap a particular lecture on a touchscreen of a smartphone app, and user device 120 may communicate content request 144 to processor 104 as a result. In some embodiments, content request 144 is generated by user device 120 as a function of an interaction between user and digital avatar.

Still referring to FIG. 1, in some embodiments, apparatus may receive content request 144 or a substitute communication from a device other than user device 120. For example, apparatus may receive a communication from a device associated with an educational content database indicating that user device 120 has requested a particular element of educational content.

Still referring to FIG. 1, in some embodiments, apparatus 100 may collect second set of educational content 148 as a function of content request 144. Second set of educational content 148 may include educational content as described above with respect to first set of educational content 116. In some embodiments, apparatus 100 may collect second set of educational content 148 from second educational content source 152. Second set of educational content 148 may be collected as described above with respect to collecting first set of educational content 116. In some embodiments, second set of educational content is selected from the list consisting of a live class, live lab, live supplemental teaching session, live tutoring session, recorded class, recorded lab, recorded supplemental teaching session, recorded tutoring session, homework assignment, research subject matter, exam, or exam preparation material.

Still referring to FIG. 1, in some embodiments, apparatus 100 may determine filtered second set of educational content 156 as a function of second set of educational content 148 and content modification model 132. In some embodiments, apparatus 100 may determine filtered second set of educational content 156 by applying content modification model 132 to second set of educational content 148. In some embodiments, only taxonomy preference model 136 is applied, such as if user has manually configured settings in this way or if prior reaction data 128 suggest that user prefers only taxonomy preference model 136. In some embodiments, only toxicity reduction model 140 is applied, such as if user has manually configured settings in this way or if prior reaction data 128 suggest that user prefers only toxicity reduction model 140. In some embodiments, both taxonomy preference model 136 and toxicity reduction model 140 are applied.

Still referring to FIG. 1, in an embodiment in which taxonomy preference model 136 includes taxonomy preference machine learning model, determining a filtered second set of educational content 156 may include inputting second set of educational content 148 into taxonomy preference machine learning model. Similarly, in an embodiment in which toxicity reduction model 140 includes toxicity reduction machine learning model, determining a filtered second set of educational content 156 may include inputting second set of educational content 148 into toxicity reduction machine learning model.

Still referring to FIG. 1, in some embodiments, apparatus 100 may communicate filtered second set of educational content 156 to user device 120. In some embodiments, communicating filtered second set of educational content 156 to user device 120 includes configuring user device 120 to communicate filtered second set of educational content 156 to user. In some embodiments, filtered second set of educational content 156 may be communicated to user using a digital avatar.

Still referring to FIG. 1, in some embodiments, filtered second set of educational content 156 may include a visual element. Communicating filtered second set of educational content 156 to user device 120 may include communicating to user device a visual element and/or visual element data structure. A visual element included in filtered second set of educational content 156 may include a visual element within second set of educational content 148. A visual element included in filtered second set of educational content 156 may include a modified version of a visual element within second set of educational content 148. For example, if the toxicity reduction model 140 indicates that gory photographs should not be shown, then a gory photograph may be blurred.

Still referring to FIG. 1, in some embodiments, a visual element data structure may include a visual element. As used herein, a “visual element” is a datum that is displayed visually to a user. In some embodiments, a visual element data structure may include a rule for displaying visual element. In some embodiments, a visual element data structure may be determined as a function of second set of educational content 148 and/or filtered second set of educational content 156. In a non-limiting example, a visual element data structure may be generated such that visual element including an undesirable element is blurred. In another non-limiting example, a visual element data structure may be generated such that visual element including an undesirable element is made black and white. In another non-limiting example, a visual element data structure may be generated such that visual element including an undesirable element has a warning indicating the type of undesirable content placed over it.

Still referring to FIG. 1, in some embodiments, visual element may include one or more elements of text, images, shapes, charts, particle effects, interactable features, and the like; in some embodiments, these may be determined for filtered second set of educational content 156 based on the features of second set of educational content 148.

Still referring to FIG. 1, a visual element data structure may include rules governing if or when visual element is displayed. In a non-limiting example, a visual element data structure may include a rule causing a visual element depicting undesirable content to be displayed when a user clicks on a button acknowledging a warning and indicating a wish to see the undesirable content anyway.

Still referring to FIG. 1, a visual element data structure may include rules for presenting more than one visual element, or more than one visual element at a time. In an embodiment, about 1, 2, 3, 4, 5, 10, 20, or 50 visual elements are displayed simultaneously.

Still referring to FIG. 1, a visual element data structure rule may apply to a single visual element or datum, or to more than one visual element or datum. A visual element data structure may categorize data into one or more categories and may apply a rule to all data in a category, to all data in an intersection of categories, or all data in a subsection of a category (such as all data in a first category and not in a second category). For example, different rules may be applied to different forms of undesirable content. A visual element data structure may rank data or assign numerical values to them. For example, numerical values may be assigned based on the severity of the undesirableness of the content. A visual element data structure may apply rules based on a comparison between a ranking or numerical value and a threshold. For example, visual element data structure rules may direct user device 120 to completely obscure content above a threshold and only blur content below a threshold. Rankings, numerical values, categories, and the like may be used to set visual element data structure rules. Similarly, rankings, numerical values, categories, and the like may be applied to visual elements, and visual elements may be applied based on them. For example, removal of an image may be ranked as a severe mitigation strategy, blurring may be ranked as less severe, and making an image black and white may be ranked as still less severe.

Still referring to FIG. 1, in some embodiments, visual element may be interacted with. For example, visual element may include an interface, such as a button or menu. In some embodiments, visual element may be interacted with using user device 120 such as a smartphone. For example, user may click on a visual element to bring up a description of why it is obscured.

Still referring to FIG. 1, a variable and/or datum described herein may be represented as a data structure. In some embodiments, a data structure may include one or more functions and/or variables, as a class might in object-oriented programming. In some embodiments, a data structure may include data in the form of a Boolean, integer, float, string, date, and the like. In a non-limiting example, a visual element data structure may include an int value representing the degree of severity of undesirableness of a particular type, such as profanity or gore. In some embodiments, data in a data structure may be organized in a linked list, tree, array, matrix, tenser, and the like. In some embodiments, a data structure may include or be associated with one or more elements of metadata. A data structure may include one or more self-referencing data elements, which processor 104 may use in interpreting the data structure. In a non-limiting example, a data structure may include “<date>” and “</date>,” tags, indicating that the content between the tags is a date.

Still referring to FIG. 1, a data structure may be stored in, for example, memory 108 or a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Still referring to FIG. 1, in some embodiments, a data structure may be read and/or manipulated by processor 104. In a non-limiting example, a visual element data structure of second set of educational content 148 may be read and converted into another form to be input into a machine learning model. In another non-limiting example, a reaction datum data structure may be read by processor 104 in order to train a machine learning model and/or determine a setting.

Still referring to FIG. 1, in some embodiments, a data structure may be calibrated. In some embodiments, a data structure may be trained using a machine learning algorithm. In a non-limiting example, a data structure may include an array of data representing the biases of connections of a neural network. In this example, the neural network may be trained on a set of training data, and a back propagation algorithm may be used to modify the data in the array. Machine learning models and neural networks are described further herein.

Still referring to FIG. 1, in some embodiments, user device 120 may communicate with user using a digital avatar. In some embodiments, receiving content request 144 from user device 120, collecting second set of educational content 148, determining filtered second set of educational content 156, and communicating filtered second set of educational content 156 to user device 120 is performed in real time.

Still referring to FIG. 1, in some embodiments, a digital avatar may include a base image and a plurality of animations of the base image. Digital avatar may be configured to receive an educational response and display an animation of the plurality of animations as a function of the educational response. As used herein, a “digital avatar” is an interactive character or entity in a virtual world. For example, a digital avatar may include a base image consisting of a computer-generated image associated with a user. As used herein, an “animation” is a form of digital medica production that includes using computer software to create moving images. For example, an avatar may be a 3 dimensional model that is capable of changing its shape with animations, such as human simulation animations like walking or falling down. An animation may also include video clips and animated clips, such as short videos used on a website, which may be a part of a longer recording. For example, an animation may be stitched together into sequences by splicing together multiple animations (e.g., short videos) to create a new, original video/animation. In an embodiment, there may be one or more post-sequence static set ups for the digital avatar which may be still or in video format. For example, a digital avatar may have a resting, default face (e.g., not showing any sign of emotion) and an expression corresponding to a previous sequence may be added. For example, a digital avatar may initially present a resting, default face devoid of emotion and a smiling, happy expression corresponding to a previous sequence may be added. In yet another embodiment, each sequence may include a label representing each sequence to which responses and/or contexts could be matched. In an embodiment, instantiating digital avatar may include generating a plurality of rules linking events, such as receipt of content request 144, to animations. This may be accomplished by generating an educational model which includes generating a plurality of responses and a plurality of rules matching inputs to responses (i.e. the response generated based on the input) and then generating pairs of all potential responses to animations or rules associating groups of responses to animations. For example, a response may be positive which may be linked to an animation of hands clapping. In another embodiment, generating a plurality of rules may also include receiving a plurality of training examples correlating responses to animations and training a classifier using the plurality of training examples, wherein the response classifier is configured to input an educational response and output a rule linking the response to an animation. The response classifier machine learning model may be trained using a supervised learning algorithm and a training data set. Training data may include inputs and corresponding predetermined outputs so that a machine-learning module may use the correlations between the provided exemplary inputs and outputs to develop an algorithm and/or relationship that then allows the machine-learning module to determine its own outputs for inputs. Training data may contain correlations that a machine-learning process may use to model relationships between two or more categories of data elements. The exemplary inputs and outputs may come from a database, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning module may determine an output, such as labels of animations or sequences of labels, for an input, such as response from a chatbot, user inputs and/or a combination of one or more inputs with one or more inputs from previous iterations. For example, labels of animations or sequences of labels may be utilized to retrieve and display animations or sequences of animations. By way of a further example, the way in which the digital avatar responds may be based on the context of an earlier conversation and/or an earlier exchange in a conversation. Correlations may indicate causative and/or predictive links between data, which may be modeled as relationships, such as mathematical relationships, by machine-learning processes, as described in further detail below. In an embodiment, various classifiers may be utilized depending on where a geographic location of a user, the time of day and/or other circumstances. Alternatively or additionally the geographic location of a user, the time of day and/or other circumstances may be utilized as training data for the classifier. In an embodiment, the geographic location of a user, the time of day and/or other circumstances may be utilized as inputs for the classifier. Each of the above steps may be performed by classifier or other machine learning model which are described in further detail below.

Still referring to FIG. 1, in some embodiments, digital avatar may be customizable. For example, user may be able to cosmetically design an avatar and choose personalized characteristics. Digital avatar may include, without limitation, an animal, human, robot, inanimate object, or the like. In an embodiment, personalized characteristics may be also derived from user's behavior. For example, user may have a unique gait which may be incorporated by the digital avatar. Digital avatar may include one or more animation files and/or video clips and may include one or more files and/or video clips of the user. In an embodiment, generating digital avatar may include creating a digital representative for simulating one or more interactions in the extended reality space. Extended reality is discussed in more detail below.

Still referring to FIG. 1, apparatus 100 may generate the digital avatar in an extended reality space, such as, without limitation, augmented reality (AR) space, virtual reality (VR) space, and/or any other digital realities. For example, extended reality space may include a virtual classroom, virtual meeting room, virtual study room, or the like. The content can span multiple sensory modalities, including visual, auditory, haptic, somatosensory and olfactory. For example, an application of augmented reality in education includes teaching global perspectives through virtual field trips, enabling students to interactively engage with other cultures. By way of another example, students who struggle with geometry may utilize augmented reality to see and manipulate 3-dimensional geometric forms. As used herein, “virtual reality” is a simulated experience that employs pose tracking and 3D near-eye displays to give the user an immersive feel of a virtual world. For example, instead of merely watching a documentary on whales, students may experience what it would be like to be a scuba diver in the water with the whales, or even, what it would be like to be a whale itself. Virtual reality may stimulate many senses usually through the use of a headset that shows 3-D graphics of the subject matter. Other senses may be stimulated such as touch, hearing, smell and the like. In an embodiment, generating digital avatar may include utilizing computer vision. Computer vision is a field of artificial intelligence (AI) enabling computers to derive information from images, videos and other inputs.

Still referring to FIG. 1, in some embodiments, apparatus 100 may be configured to generate digital avatar by utilizing a digital avatar model. As used herein, a “digital avatar model” is a component configured to generate a digital avatar associated with the entity utilizing a machine learning model. In an embodiment, digital avatar model may include 3D modeling and/or animation software. In another embodiment, digital avatar model may be hosted in a decentralized platform (i.e., web 3.0). Digital avatar may be made of a plurality of feature elements, which may include diverse types of features from a digital avatar such as image features, frame features, sound features, graphical features, and the like. Apparatus 100 may generate a digital avatar 128 using the digital avatar model by utilizing digital avatar training data comprising information from a plurality of pre-existing digital avatars from a digital avatar database. Digital avatar training data may include a machine-learning training algorithm. Machine learning algorithms may include unsupervised machine learning algorithms such as clustering models, k-means clustering, hierarchical clustering, anomaly detection, local outlier factor, neural networks and the like. Machine-learning may include supervised machine learning algorithms using digital avatar training data. Machine-learning algorithms may include lazy-learning. In an embodiment, apparatus 100 may create realistic digital avatars to interact with students in real time, 24 hours a day. For example, a learner/student may ask digital avatar a question and digital avatar will answer in real time. The use of dynamic one on one tutoring between digital avatar and student may be enabled.

Still referring to FIG. 1, in some embodiments, the generation of a digital avatar may include training, using the plurality of user data items and digital avatar training data, a machine-learning model. Training data, as used in this disclosure, is data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), enabling processes or devices to detect categories of data. Generating a digital avatar includes training the digital avatar model using digital avatar training data. As used herein, “digital avatar training data” is data collected from a plurality of past, pre-generated digital avatars that are currently used to help classify and distinguish user data received to generate the current digital avatar.

Still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below. Training data used by apparatus 100 may correlate any input data as described in this disclosure to any output data as described in this disclosure.

Still referring to FIG. 1, apparatus 100 may be configured to generate digital avatar model using a first feature learning algorithm and digital avatar training data. A “feature learning algorithm,” as used herein, is a machine-learning algorithm that identifies associations between elements of data in a training data set, where particular outputs and/or inputs are not specified. For instance, and without limitation, a feature learning algorithm may detect co-occurrences of sets of user data items with each other and with digital avatars. Apparatus 100 may perform a feature learning algorithm by dividing user data items from a given user into various sub-combinations of such data to create user data sets as described above and evaluate which user data sets tend to co-occur with which other user data sets, and digital avatars. In an embodiment, first feature learning algorithm may perform clustering of data; for instance, a number of clusters into which data from training data sets may be sorted using feature learning may be set as a number of digital avatars.

Still referring to FIG. 1, in some embodiments, a digital avatar may be consistent with a virtual avatar as described in U.S. patent application Ser. No. 18/122,298, filed on Mar. 16, 2023, and titled “APPARATUS AND METHOD FOR AN EDUCATION PLATFORM AND ECOSYSTEM USING EXTENDED REALITY,” the entirety of which is hereby incorporated by reference.

Still referring to FIG. 1, in some embodiments, apparatus 100 may communicate a set of educational content to user device 120, may receive reaction datum 128, and may send a second communication to user device 120 configuring user device 120 to display an altered version of the educational content to user; displaying the altered version of the educational content may be done as a function of reaction datum 128.

Still referring to FIG. 1, in some embodiments, apparatus 100 may communicate directly with user without use of user device 120. Still referring to FIG. 1, in some embodiments, apparatus 100 may include a user interface. User interface may include an output interface and an input interface.

Still referring to FIG. 1, in some embodiments, output interface may include one or more elements through which apparatus 100 may communicate information to a user. In a non-limiting example, output interface may include a display. A display may include a high resolution display. A display may output images, videos, and the like to a user. In another non-limiting example, output interface may include a speaker. A speaker may output audio to a user. In another non-limiting example, output interface may include a haptic device. A speaker may output haptic feedback to a user.

Still referring to FIG. 1, in some embodiments, input interface may include controls for operating apparatus 100. Such controls may be operated by a user. Input interface may include, in non-limiting examples, a camera, microphone, keyboard, touch screen, mouse, joystick, foot pedal, button, dial, and the like. Input interface may accept, in non-limiting examples, mechanical input, audio input, visual input, text input, and the like. In some embodiments, audio inputs into input interface may be interpreted using an automatic speech recognition function, allowing a user to control apparatus 100 via speech.

Still referring to FIG. 1, in some embodiments, apparatus 100 may notify user that changes have been made to educational content. In some embodiments, apparatus 100 may specify to user what has been changed about the educational content. In some embodiments, apparatus 100 may include a feature allowing user to view an original version of educational content.

Still referring to FIG. 1, personalizing educational content for users as described herein may allow for educational content that is made to be generic and used for a variety of students to be customized and improved for the needs of particular students. For example, a scientific journal article may contain a complicated description of a concept that includes a lot of jargon, and apparatus 100 may modify the article such that the content is understandable for a student that is not knowledgeable about the relevant topic. In another example, a professor may use jokes including profanity to keep students engaged in an online class, and apparatus 100 may replace or remove the profanity when presenting the lecture to a student that is particularly sensitive to profanity.

Still referring to FIG. 1, in some embodiments, it may be difficult to design educational content such that it is personalized for a wide variety of potential student needs. The methods and systems described herein may allow for generic educational content to be customized for individual students. These systems and methods also do so in a way that gets around problems associated with manual input of extensive amounts of user data, namely the high startup cost of initiating any model using such a system. Through the use of passive methods of data collection, such as using machine vision to determine user reactions, and association of that data with elements of educational content, these systems and methods may be performed without initial user data input or with relatively minimal amounts of initial user data input. Such a design may allow students to receive customized educational content in a way that has a low startup cost in the form of time and troubleshooting, which may allow for improved learning outcomes.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, inputs may include second set of educational content 148 and outputs may include filtered second set of educational content 156.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to specific types of undesirable feature such as profanity, gore, and misinformation. As described above, in some embodiments, different machine learning models may be used based on settings or machine learning models may be trained to alter educational content in different ways. Such categorization may be used to train machine learning models to achieve specific tasks such as removing only profanity rather than removing everything possibly recognized by toxicity reduction model 140.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include educational content as described above as inputs, filtered educational content as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 2, apparatus 100 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 2, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user feedback for users belonging to a particular cohort of persons may be averaged together to determine the cohort accuracy score for that particular cohort of persons and used as described above. Accuracy score or another score as described above may indicate a degree of retraining needed for a machine-learning model such as a classifier; apparatus 100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

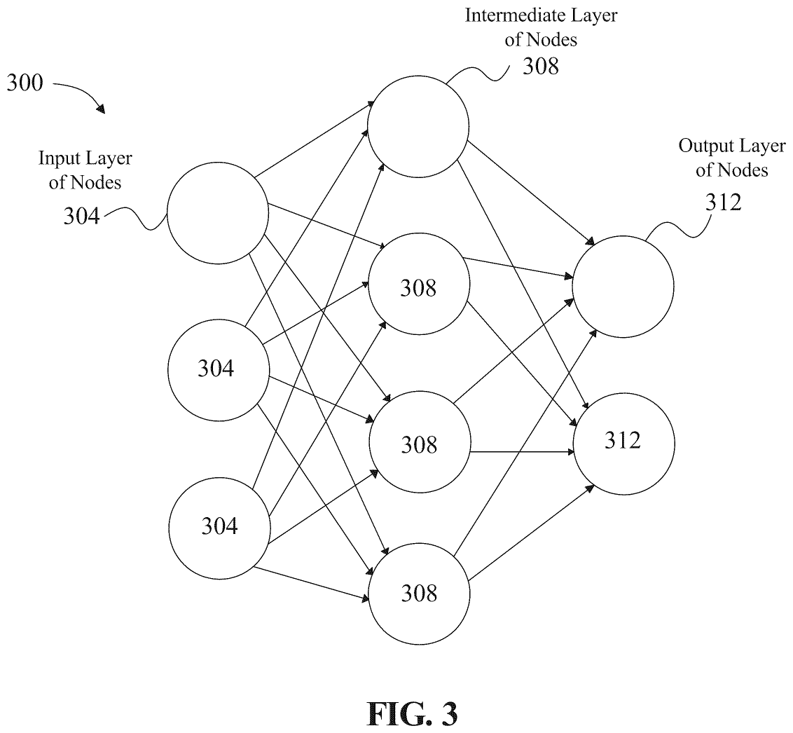

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

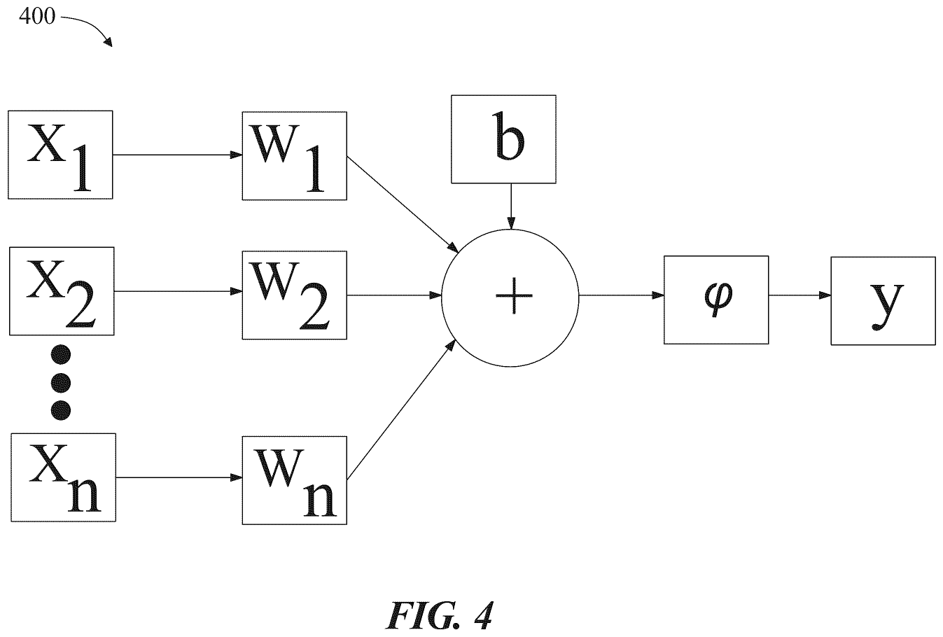

Referring now to FIG. 4, an exemplary embodiment of a node 400 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 4, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

Still referring to FIG. 4, in some embodiments, a convolutional neural network may learn from images. In non-limiting examples, a convolutional neural network may perform tasks such as classifying images, detecting objects depicted in an image, segmenting an image, and/or processing an image. In some embodiments, a convolutional neural network may operate such that each node in an input layer is only connected to a region of nodes in a hidden layer. In some embodiments, the regions in aggregate may create a feature map from an input layer to the hidden layer. In some embodiments, a convolutional neural network may include a layer in which the weights and biases for all nodes are the same. In some embodiments, this may allow a convolutional neural network to detect a feature, such as an edge, across different locations in an image.

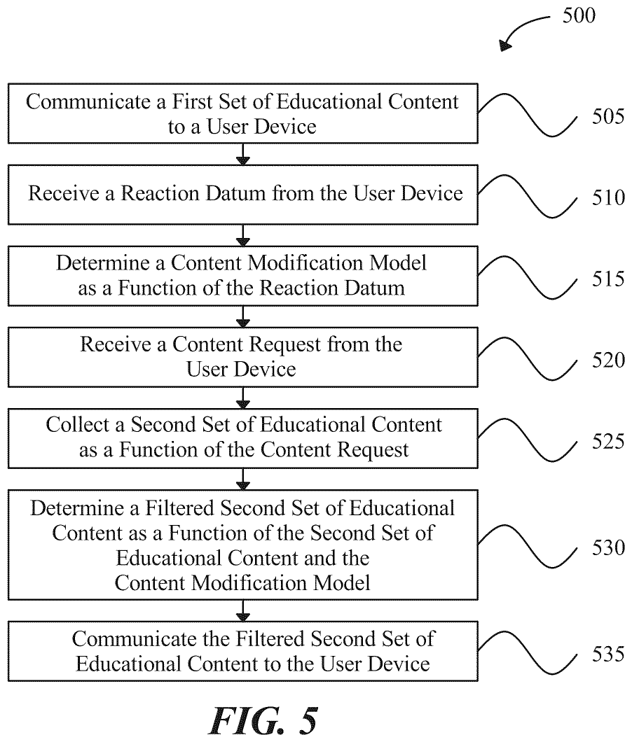

Referring now to FIG. 5, an exemplary embodiment of a method 500 of modifying educational content is illustrated. One or more elements of method 500 may be achieved using at least a processor. One or more elements of method 500 may be achieved as described above with reference to FIG. 1.

Still referring to FIG. 5, in some embodiments, method 500 may include communicating a first set of educational content to a user device 505.

Still referring to FIG. 5, in some embodiments, method 500 may include receiving a reaction datum from the user device 510. In some embodiments, receiving a reaction datum from the user device comprises analyzing user sentiment. In some embodiments, analyzing user sentiment comprises analyzing a facial response using a machine vision system. In some embodiments, analyzing a facial response using a machine vision system comprises inputting into a machine learning model image data depicting a user's face upon the user receiving the first set of educational content and receiving from the machine learning model a datum indicating a feature of the user's reaction to the first set of educational content.

Still referring to FIG. 5, in some embodiments, method 500 may include determining a content modification model as a function of the reaction datum 515. In some embodiments, content modification model comprises a taxonomy preference model. In some embodiments, taxonomy preference model comprises a taxonomy preference machine learning model. In some embodiments, content modification model comprises a toxicity reduction model. In some embodiments, toxicity reduction model comprises a toxicity reduction machine learning model. In some embodiments, taxonomy preference model may include a plurality of taxonomy preference machine learning models, wherein each of the plurality of taxonomy preference machine learning models is trained to modify educational content language, wherein determining a filtered second set of educational content as a function of the second set of educational content and the content modification model may include selecting a taxonomy preference machine learning model from the plurality of taxonomy preference machine learning models, inputting the second set of educational content into the taxonomy preference machine learning model, and receiving from the taxonomy preference machine learning model the filtered second set of educational content. In some embodiments, toxicity reduction model may include a plurality of toxicity reduction machine learning models, wherein each of the plurality of toxicity reduction machine learning models is trained to modify educational content language, wherein determining a filtered second set of educational content as a function of the second set of educational content and the content modification model may include selecting a toxicity reduction machine learning model from the plurality of toxicity reduction machine learning models, inputting the second set of educational content into the toxicity reduction machine learning model, and receiving from the toxicity reduction machine learning model the filtered second set of educational content. In some embodiments, determining a content modification model as a function of the reaction datum comprises identifying a prior content modification model and updating the prior content modification model as a function of the reaction datum.

Still referring to FIG. 5, in some embodiments, method 500 may include receiving a content request from the user device 520. In some embodiments, content request is generated by the user device as a function of an interaction between a user and a digital avatar.

Still referring to FIG. 5, in some embodiments, method 500 may include collecting a second set of educational content as a function of the content request 525. In some embodiments, first set of educational content and the second set of educational content are each independently selected from the list consisting of a live class, live lab, live supplemental teaching session, live tutoring session, recorded class, recorded lab, recorded supplemental teaching session, recorded tutoring session, homework assignment, research subject matter, exam, or exam preparation material.

Still referring to FIG. 5, in some embodiments, method 500 may include determining a filtered second set of educational content as a function of the second set of educational content and the content modification model 530.

Still referring to FIG. 5, in some embodiments, method 500 may include communicating the filtered second set of educational content to the user device 535. In some embodiments, receiving a content request from the user device, collecting a second set of educational content as a function of the content request, determining a filtered second set of educational content as a function of the second set of educational content and the content modification model, and communicating the filtered second set of educational content to the user device is performed in real time.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

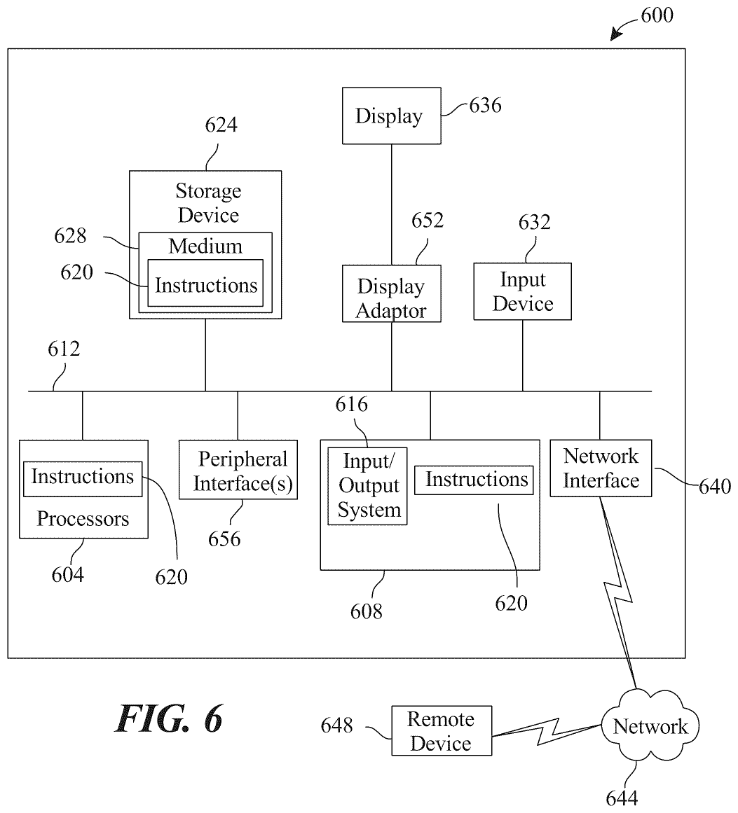

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for modification of educational content, the apparatus comprising:
at least a processor; and
a memory communicatively connected to the at least processor, the memory containing instructions configuring the at least processor to:
receive user data including information about a user;
generate a digital avatar based on the user data by utilizing a digital avatar model, wherein the digital avatar model is trained using a plurality of user data items and digital avatar training data comprising information from a plurality of pre-existing digital avatars from a digital avatar database;
communicate a first set of educational content to a user device;
receive a reaction datum comprising image data from the user device based on an interaction between the user and the digital avatar, wherein the user device comprises a machine vision system further comprising an image sensor configured to capture image data within visible and non-visible ranges of electromagnetic radiation, wherein the at least a processor is configured to, using the machine vision system, perform registration of physical movement and facial expression within a space of the image data by:
performing transformations to orient the image data relative to a three-dimensional coordinate system:
verifying the transformations using a feature detection algorithm;
detecting a third dimension of registration representing depth by comparing at least two frames of image data and deriving z-axis values of points on objects within the image data using stereoscopic image recognition and edge detection; and
iteratively estimating and comparing coordinates of points on objects within the image data using an error function to refine the coordinates until a threshold level of error is achieved;
determine a content modification model based on the reaction datum, wherein the content modification model comprises a toxicity reduction model, wherein the toxicity reduction model is configured to remove portions of the first set of educational content, and wherein the removed portions of the first set of educational content comprise profanity and gory photographs;
receive a content request from the user device;
collect a second set of educational content based on the content request;
determine a filtered second set of educational content based on the second set of educational content and the content modification model; and
communicate the filtered second set of educational content to the user device utilizing the digital avatar.

2. The apparatus of claim 1, wherein the content modification model comprises a taxonomy preference model.

3. The apparatus of claim 2, wherein the taxonomy preference model comprises a plurality of taxonomy preference machine learning models, wherein each of the plurality of taxonomy preference machine learning models is trained to modify educational content language, wherein determining a filtered second set of educational content as based on the second set of educational content and the content modification model comprises selecting a taxonomy preference machine learning model from the plurality of taxonomy preference machine learning models, inputting the second set of educational content into the taxonomy preference machine learning model, and receiving from the taxonomy preference machine learning model the filtered second set of educational content.

4. (canceled)

5. The apparatus of claim 1, wherein the toxicity reduction model comprises a plurality of toxicity reduction machine learning models, wherein each of the plurality of toxicity reduction machine learning models is trained to modify educational content language, wherein determining a filtered second set of educational content based on the second set of educational content and the content modification model comprises selecting a toxicity reduction machine learning model from the plurality of toxicity reduction machine learning models, inputting the second set of educational content into the toxicity reduction machine learning model, and receiving from the toxicity reduction machine learning model the filtered second set of educational content.

6. The apparatus of claim 1, wherein receiving a reaction datum from the user device comprises analyzing user sentiment, wherein analyzing user sentiment comprises analyzing a facial response using a machine vision system.

7. The apparatus of claim 6, wherein analyzing a facial response using a machine vision system comprises inputting into a machine learning model image data depicting a user's face upon the user receiving the first set of educational content and receiving from the machine learning model a datum indicating a feature of the user's reaction to the first set of educational content.

8. The apparatus of claim 1, wherein the content request is generated by the user device based on another interaction between the user and the digital avatar.

9. The apparatus of claim 1, wherein determining a content modification model as based on the reaction datum comprises identifying a prior content modification model and updating the prior content modification model as a function of the reaction datum.

10. The apparatus of claim 1, wherein first set of educational content and the second set of educational content are each independently selected from a list consisting of a live class, live lab, live supplemental teaching session, live tutoring session, recorded class, recorded lab, recorded supplemental teaching session, recorded tutoring session, homework assignment, research subject matter, exam, and exam preparation material.

11. A method of modifying educational content, the method comprising:
receiving user data including information about a user;
generating, using at least a processor, a digital avatar based on the user data by utilizing a digital avatar model, wherein the digital avatar model is trained using a plurality of user data items and digital avatar training data comprising information from a plurality of pre-existing digital avatars from a digital avatar database;
communicating, using at least a processor, a first set of educational content to a user device;
receiving, using at least a processor, a reaction datum comprising image data from the user device based on an interaction between the user and the digital avatar, wherein the user device comprises a machine vision system further comprising an image sensor configured to capture image data within visible and non-visible ranges of electromagnetic radiation, wherein the at least a processor is configured to, using the machine vision system, perform registration of physical movement and facial expression within a space of the image data by:
performing transformations to orient the image data relative to a three-dimensional coordinate system:
verifying the transformations using a feature detection algorithm:
detecting a third dimension of registration representing depth by comparing at least two frames of image data and deriving z-axis values of points on objects within the image data using stereoscopic image recognition and edge detection; and
iteratively estimating and comparing coordinates of points on objects within the image data using an error function to refine the coordinates until a threshold level of error is achieved:
determining, using at least a processor, a content modification model based on the reaction datum, wherein the content modification model comprises a toxicity reduction model, wherein the toxicity reduction model is configured to remove portions of the first set of educational content, and wherein the removed portions of the first set of educational content comprise profanity and gory photographs;
receiving, using at least a processor, a content request from the user device;
collecting, using at least a processor, a second set of educational content based on the content request;
determining, using at least a processor, a filtered second set of educational content based on the second set of educational content and the content modification model; and
communicating, using at least a processor, the filtered second set of educational content to the user device utilizing the digital avatar.

12. The method of claim 11, wherein the content modification model comprises a taxonomy preference model.

13. The method of claim 12, wherein the taxonomy preference model comprises a plurality of taxonomy preference machine learning models, wherein each of the plurality of taxonomy preference machine learning models is trained to modify educational content language, wherein determining a filtered second set of educational content as based on the second set of educational content and the content modification model comprises selecting a taxonomy preference machine learning model from the plurality of taxonomy preference machine learning models, inputting the second set of educational content into the taxonomy preference machine learning model, and receiving from the taxonomy preference machine learning model the filtered second set of educational content.

14. (canceled)

15. The method of claim 11, wherein the toxicity reduction model comprises a plurality of toxicity reduction machine learning models, wherein each of the plurality of toxicity reduction machine learning models is trained to modify educational content language, wherein determining a filtered second set of educational content based on the second set of educational content and the content modification model comprises selecting a toxicity reduction machine learning model from the plurality of toxicity reduction machine learning models, inputting the second set of educational content into the toxicity reduction machine learning model, and receiving from the toxicity reduction machine learning model the filtered second set of educational content.

16. The method of claim 11, wherein receiving a reaction datum from the user device comprises analyzing user sentiment, wherein analyzing user sentiment comprises analyzing a facial response using a machine vision system.

17. The method of claim 16, wherein analyzing a facial response using a machine vision system comprises inputting into a machine learning model image data depicting a user's face upon the user receiving the first set of educational content and receiving from the machine learning model a datum indicating a feature of the user's reaction to the first set of educational content.

18. The method of claim 11, wherein the content request is generated by the user device based on an interaction between a user and a digital avatar.

19. The method of claim 11, wherein determining a content modification model based on the reaction datum comprises identifying a prior content modification model and updating the prior content modification model as a function of the reaction datum.

20. The method of claim 11, wherein first set of educational content and the second set of educational content are each independently selected from a list consisting of a live class, live lab, live supplemental teaching session, live tutoring session, recorded class, recorded lab, recorded supplemental teaching session, recorded tutoring session, homework assignment, research subject matter, exam, and exam preparation material.
